(19) United States
(12) Patent Application Publication
(10) Pub. No.: US 2013/0141843 A1
(43) Pub. Date: Jun. 6, 2013

(54) Folding Arm Ballast

(71) Applicants: Brian Howard Wald, Los Angeles, CA (US); Thomas Woods, Huntington Beach, CA (US); Kevin Yang, Lomita, CA (US); Fengchang Hu, Torrance, CA (US); Alvaro Garcia, Torrance, CA (US)

(72) Inventors: Brian Howard Wald, Los Angeles, CA (US); Thomas Woods, Huntington Beach, CA (US); Kevin Yang, Lomita, CA (US); Fengchang Hu, Torrance, CA (US); Alvaro Garcia, Torrance, CA (US)

(21) Appl. No.: 13/310,040

(22) Filed: Dec. 2, 2011

(51) Int. Cl. H02B 1/30

(52) U.S. Cl. 361/674

(57) ABSTRACT

A folding ballast has a ballast housing having an elongated shape. A first socket arm is mounted to the ballast housing at a first socket arm joint, and the first socket arm has a first closed position parallel to the ballast. The first socket arm has a first open position perpendicular to the ballast. A second socket arm is mounted to the ballast housing at a second socket arm joint, and the second socket arm has a second closed position parallel to the ballast. The second socket arm has a second open position perpendicular to the ballast. A first socket is mounted to the first socket arm, and the first socket is electrically connected to the ballast housing. A second socket is mounted to the second socket arm, and the second socket is electrically connected to the ballast housing.

### FIELD OF THE INVENTION

The present invention is in the field of electronic ballasts.

### DISCUSSION OF RELATED ART

A variety of electronic ballasts have connected sockets and socket arms which are integrated with the housing of the ballast as a single formed housing for an electronic component. An integral housing for ballast and fluorescent lamps was described in U.S. Pat. No. 5,349,508 issued Sep. 20, 1994 to Karbaf, the disclosure of which is incorporated herein by reference. Karbaf provided a integral housing for the electronic ballast and socket arms.

Other ballast mounting techniques include mounting the lamps to the ballast directly using the ballast housing as a lamp fixture frame, such as shown in U.S. Pat. No. 6,652,119 issued Nov. 25, 2003 to Barton, the disclosure of which is incorporated herein by reference. The ballast mounting technique of Barton utilizes all four long faces of the rectangular ballast housing to provide a multi-lamp solution.

A different ballast mounting technique is to have the ballast formed with a pair of channels for receiving lamps such as shown in Correll United States patent fight 720,546 issued Feb. 28, 1998, the disclosure of which is incorporated herein by reference. Yet others have mounted the ballast to the lamp directly such that the lamp and the ballast are both disposable.

### SUMMARY OF THE INVENTION

A folding ballast has a ballast housing having an elongated shape. A first socket arm is mounted to the ballast housing at a first socket arm joint, and the first socket arm has a first closed position parallel to the ballast. The first socket arm has a first open position perpendicular to the ballast. A second socket arm is mounted to the ballast housing at a second socket arm joint, and the second socket arm has a second closed position parallel to the ballast. The second socket arm has a second open position perpendicular to the ballast. A first socket is mounted to the first socket arm, and the first socket is electrically connected to the ballast housing. A second socket is mounted to the second socket arm, and the second socket is electrically connected to the ballast housing.

Optionally, a socket opening is formed in the first socket arm, and the socket fits in the socket opening. The socket arm connection indent has an indent opening. The first socket arm offset is located at an offset lateral extension of the first socket arm, and the first socket arm is mounted to the first socket arm offset. The first socket arm joint is formed on the first socket arm offset. The second socket arm offset is located at an offset lateral extension of the second socket arm, and the second socket arm is mounted to the second socket arm offset. The second socket arm joint is formed on the second socket arm offset.

The ballast body end has a horizontal planar shape and receives the first socket arm joint and the second socket arm joint. The first socket arm joint and the second socket arm joint are both vertically mounted to the ballast body end. The flat portion of a socket arm offset meeting with an inside surface of a ballast body sidewall limits movement to approximately 90° between a first open position and a first closed position of the first socket arm. The folding socket bar may unfold from a socket bar closed position to a socket bar opened position and includes a socket bar line connecting between the socket bar and the ballast housing.

### BRIEF DESCRIPTION OF THE DRAWINGS

FIG. 1 is a partially open position view of the present invention.

FIG. 2 is a perspective view showing the underside of an installation of the present invention in a lighting fixture.

FIG. 3 is a perspective view showing the top side of an installation of the present invention in a lighting fixture.

FIG. 4 is a perspective view of the ballast with socket arms in closed position.

FIG. 5 is a perspective view of the socket bar in closed position.

FIG. 6 is a perspective view of a socket arm.

FIG. 7 is a perspective view of a socket bar.

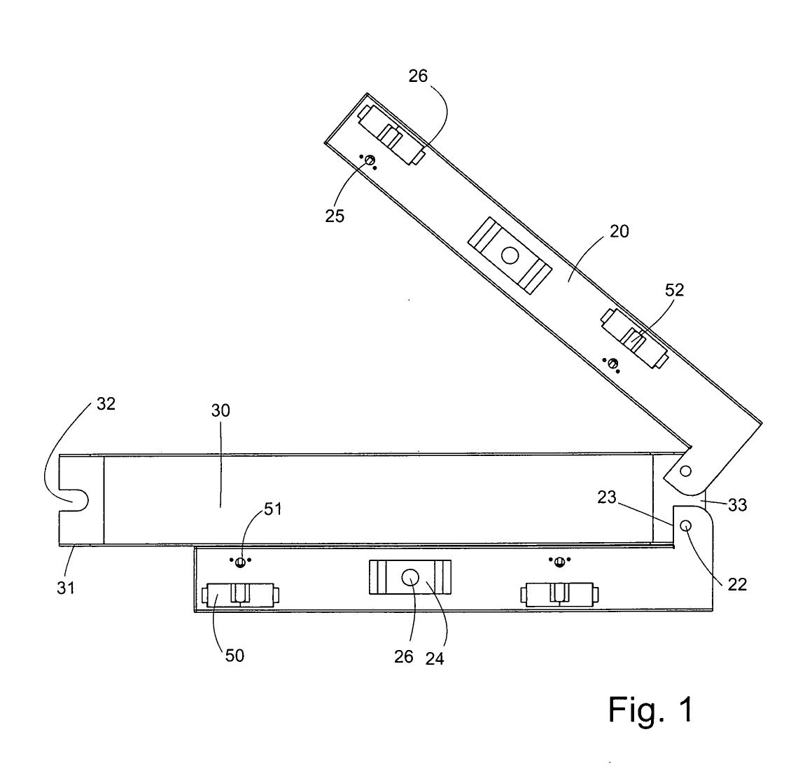

The following call out list of elements references the call out numbers of the elements in the drawings.

20 Socket Arm

22 Socket Arm Joint

24 Socket Arm Connection Indent

25 Socket Snap Opening

26 Indent Opening

30 Ballast Body

31 Ballast Body Sidewall

32 Ballast Body Notch

33 Ballast Body End

40 Socket Bar

41 Socket Bar Line

42 End Wall

43 Sidewall

44 Wires

45 Bottom Opening

50 Socket

51 Socket Snap

52 Socket Slot

88 Single Joint

### DETAILED DESCRIPTION OF THE PREFERRED EMBODIMENT

The ballast body 30 generally contains electronic components for controlling and managing power from a power source to one or more lamps such as fluorescent lamps. The ballast body 30 and socket arms 20 can be made of stamped or bended metal sheets. The socket arms 20 have electronic components including wiring connecting between the sockets 50 and the ballast body 30. The ballast body 30 includes fluorescent lamp ballast within.

The present invention includes a socket arm assembly 20 that has a first socket arm and a second socket arm. The first socket arm and the second socket arm are swivel mounted to a ballast body 30. The socket arms swivel approximately 90° from a closed position parallel to the ballast body 30 to an open position where the socket arms are at a right angle to the ballast body 30. The socket arms 20 are mounted to the ballast body 30 at a socket arm joint 22. The socket arm joint 22 is formed on a base portion of a flange extending from the ballast body 30 between a pair of ballast body sidewalls 31. The flange extends from the ballast body end 33. Opposite the ballast body end 33, a ballast body notch 32 provides a screw or bolt or post connection to a light fixture. The ballast body notch 33 is disposed on a flange between a pair of ballast body sidewalls 31.

The socket arm 20 has a socket arm offset 23 which is a normal extension from the socket arm 20. The socket arm 20 preferably abuts the ballast body 30 in a closed position. The socket arm offset 23 has a flat surface that abuts an inside surface of a ballast body sidewall 31 when the socket arm 20 is in open position so that the inside surface of the ballast body sidewall 31 acts as a stopper against the socket arm offset 23. The socket arm 20 also has a socket opening 26 and a socket snap opening 25. The socket opening 26 is generally rectangular for receiving a socket having a rectangular footprint. The socket snap opening 25 is generally rounded for receiving a round profile socket snap 51. Each socket 50 can snap into each socket opening 26 without use of tools. The socket slot 52 formed on each socket 50 receives a terminal of a lamp which can be a fluorescent lamp.

Optionally, an indent opening 26 can be formed on a socket arm connection indent 24 formed from a punched or drawn portion of a top flat metal portion of a socket arm 20. The indent opening 26 could allow screw or snap connection to a lighting fixture. The indent opening 26 is formed at a lower level than a main surface of the socket arm 20.

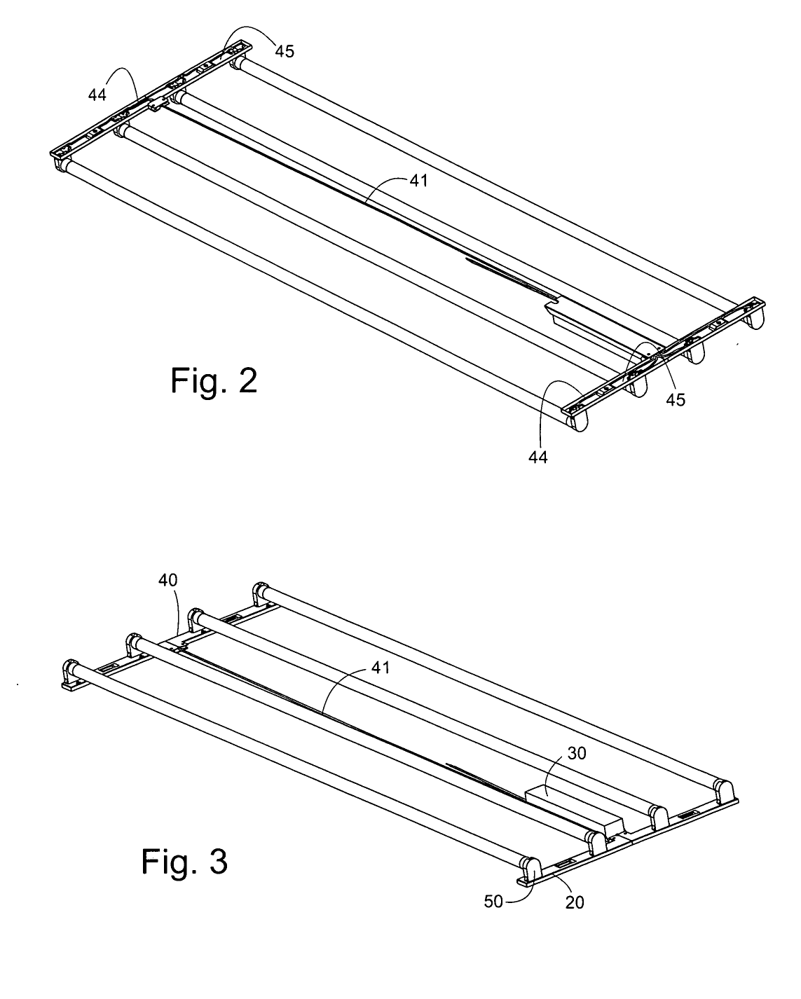

On an underside of the fluorescent lamp ballast as seen in FIG. 2, a bottom opening 45 is seen as disposed on an underside of the socket arm 20 and the socket bar 40. The bottom opening 45 is defined by the end wall 42 and sidewall 43 of the socket bar 40 and of the socket arm 20. The socket bar 40 has wires 44 making electrical connection between the sockets and the ballast. The socket arm located opposite the socket bar 40 also has wires 44 making electrical connection between the sockets and the ballast. A socket bar line 41, FIG. 3 connects between the socket bar 40 and the ballast body 30.

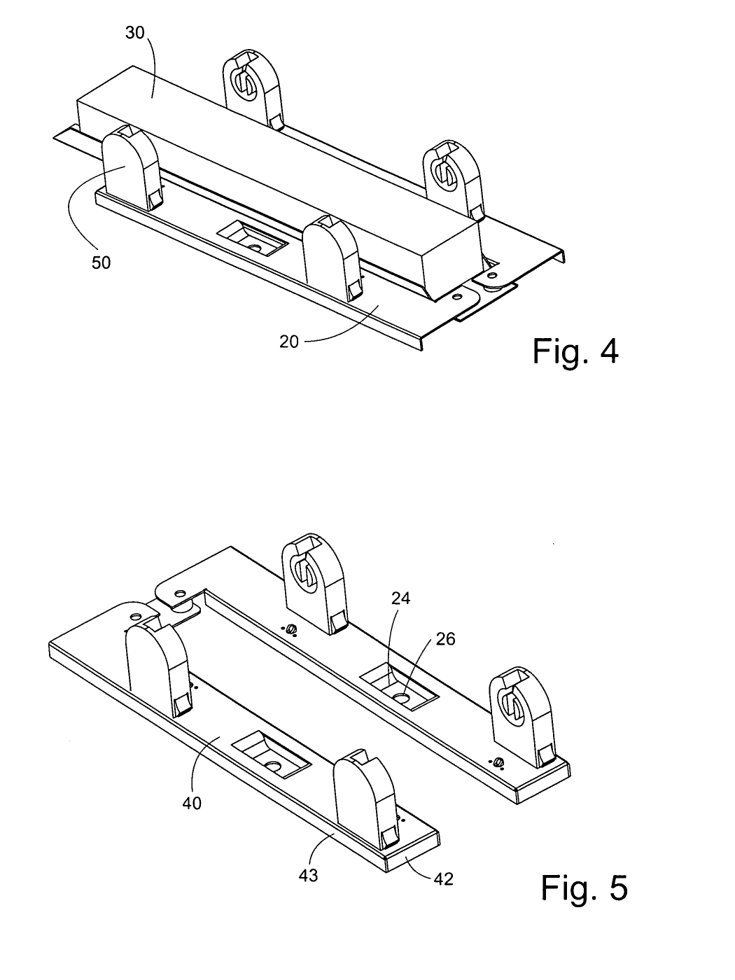

The ballast body 30 can fold up into a closed position with the socket arms 20, FIG. 4. Similarly, the socket bar 40, FIG. 5 can fold up into a closed position. The socket bar 40 can be shipped with the ballast body 30 and the socket arms 20 by inverting the socket bar 40 and staggering the sockets 50 of the socket arms 20 with the sockets 50 of the socket bar 40. In folded configuration, the two members fit together loosely to provide condensed space usage.

During installation, a user opens the packaging and removes the ballast body 30 from the socket bar 40. The user unfolds the socket bar 40. In open position, each arm of the socket bar 40, FIG. 3 is folded 90° so that the socket arms rotate from a first parallel position to a second parallel position. The user also unfolds the socket arms 20 from the ballast body 30. Now that the socket bar 40 and the ballast body 30 are both an open position, the user mounts the socket bar 40 and the ballast body 30 to the lighting fixture. A socket bar line 41 can be pre-connected to the ballast body 30 so that a user does not need to manually make such connection.

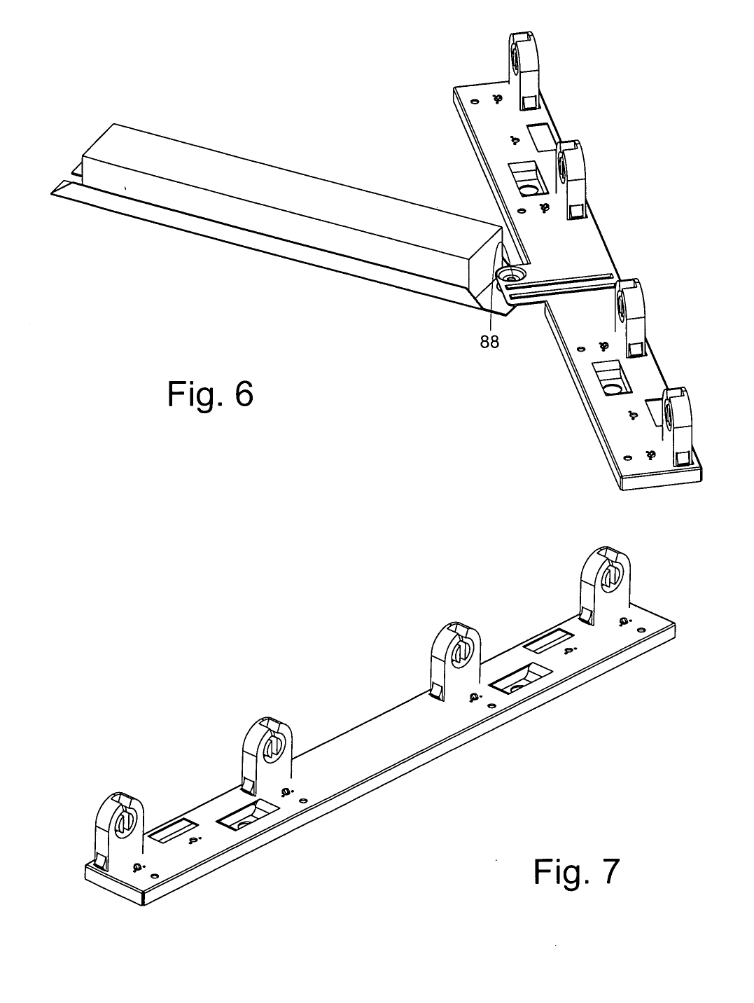

Optionally, a first socket arm and a second socket arm can be fused together or integrally formed so that they remain parallel as seen in FIG. 6. In this case, the single joint 88 provides rotation for both the first socket arm and the second socket arm. The first socket arm may have a pair of sockets and the second socket arm may have a pair of sockets. The pair a pair of sockets can comprise a total of four sockets on the first and second socket arm. During rotation of the first and second socket arm relative to the ballast body, wires maintain electrical contact between the ballast body and the sockets. If the first socket arm and second socket arm are fused together, the socket bar can be formed of a fused first socket bar arm and a second socket bar arm such that the first socket bar arm does not rotate relative to the second socket arm as seen in FIG. 7. Accordingly, the present invention may comprise only a single socket arm joint at the junction of the ballast housing and the first or second socket arm.

Although the invention has been disclosed in detail with reference only to the preferred embodiments, those skilled in the art will appreciate that various other embodiments can be provided without departing from the scope of the invention. Accordingly, the invention is defined only by the claims set forth below.

1. A folding ballast comprising:
a. a ballast housing having an elongated shape;
b. a first socket arm mounted to the ballast housing at a first socket arm joint, wherein the first socket arm has a first closed position parallel to the ballast, wherein the first socket arm has a first open position perpendicular to the ballast;
c. a second socket arm mounted to the ballast housing, wherein the second socket arm has a second closed position parallel to the ballast, wherein the second socket arm has a second open position perpendicular to the ballast;
d. a first socket mounted to the first socket arm, wherein the first socket is electrically connected to the ballast housing;
e. a second socket mounted to the second socket arm, wherein the second socket is electrically connected to the ballast housing.

2. The folding ballast of claim 1, further comprising a socket opening formed in the first socket arm, wherein the socket fits in the socket opening.

3. The folding ballast of claim 1, further comprising a socket arm connection indent having an indent opening.

4. The folding ballast of claim 1, further comprising a first socket arm offset located at an offset lateral extension of the first socket arm, wherein the first socket arm is mounted to the first socket arm offset, wherein the first socket arm joint is formed on the first socket arm offset.

5. The folding ballast of claim 4, further comprising a second socket arm offset located at an offset lateral extension of the second socket arm, wherein the second socket arm is mounted to the second socket arm offset, wherein a second socket arm joint is formed on the second socket arm offset.

6. The folding ballast of claim 1, further comprising a ballast body end having a horizontal planar shape and receiving the first socket arm joint, wherein the first socket arm joint and the second socket arm joint are both vertically mounted to the ballast body end.

7. The folding ballast of claim 1, further comprising a flat portion of a socket arm offset meeting with an inside surface of a ballast body sidewall for limiting movement to approximately 90° between a first open position and a first closed position of the first socket arm.

8. The folding ballast of claim 1, further comprising a folding socket bar, wherein the socket bar unfolds from a socket bar closed position to a socket bar opened position, further comprising a socket bar line connecting between the socket bar and the ballast housing.

9. The folding ballast of claim 8, further comprising a socket opening formed in the first socket arm, wherein the socket fits in the socket opening.

10. The folding ballast of claim 8, further comprising a socket arm connection indent having an indent opening.

11. The folding ballast of claim 8, further comprising a first socket arm offset located at an offset lateral extension of the first socket arm, wherein the first socket arm is mounted to the first socket arm offset, wherein the first socket arm joint is formed on the first socket arm offset.

12. The folding ballast of claim 11, further comprising a second socket arm offset located at an offset lateral extension of the second socket arm, wherein the second socket arm is mounted to the second socket arm offset, wherein a second socket arm joint is formed on the second socket arm offset.

13. The folding ballast of claim 8, further comprising a ballast body end having a horizontal planar shape and receiving the first socket arm joint and the second socket arm joint, wherein the first socket arm joint and a second socket arm joint are both vertically mounted to the ballast body end.

14. The folding ballast of claim 8, further comprising a flat portion of a socket arm offset meeting with an inside surface of a ballast body sidewall for limiting movement to approximately 90° between a first open position and a first closed position of the first socket arm.
